(19) United States
(12) Patent Application Publication
(10) Pub. No.: US 2010/0071001 A1
(43) Pub. Date: Mar. 18, 2010

(54) METHOD AND APPARATUS FOR SEARCHING EPG

(76) Inventor: Kyong Soo Hwang, Gyoungsangbuk-do (KR)

Correspondence Address: KED & ASSOCIATES, LLP, P.O. Box 221200, Chantilly, VA, 20153-1200, US

(21) Appl. No.: 12/447,588

(22) PCT Filed: Dec. 6, 2007
(86) PCT No.: PCT/KR07/06298

§ 371 Date: Apr. 28, 2009

(30) Foreign Application Priority Data
Dec. 7, 2006 (KR) 10-2006-0123553

(51) Int. Cl. H04N 5/445

(52) U.S. Cl. 725/40; 725/53; 725/44

(57) ABSTRACT

Provided are a method and apparatus for rapidly and exactly searching an electronic program guide (EPG) for a desired program. Even when only a program search command is input, program representative titles detected from an EPG are display in a sequential order based on a user command (e.g., in hangeul consonant order or alphabetical order). Therefore, a program search screen can be more easily recognized.

### TECHNICAL FIELD

The present disclosure relates to a display device, and more particularly, to a method and apparatus for rapidly and exactly searching an electronic program guide (EPG) for a desired program.

### BACKGROUND ART

In a digital television (TV) broadcasting method, a television signal is converted into a digital signal and is transmitted to houses through a cable or a satellite. Then, a user can watch a program from the received digital signal using a set-top box.

The number of digital TV broadcasting service providers has been increased, and the number of programs and channels provided by service providers has been also increased. As a result, much more specialized or customized digital TV channels are available so that a user can easily select a desired program from a variety of programs.

Meanwhile, digital TV broadcasting systems transmit electronic program guide (EPG) information to allow views to find a desired program more easily using the EPG information. That is, views can easily find a desired program using the received EPG information.

A program and service information protocol (PSIP) is a standard for defining EPG information and system information (SI).

The PSIP is established by advanced television systems committee for terrestrial and cable digital broadcasting. According to the PSIP, various information can be provided by parsing messages encoded by a moving picture experts group (MPEG)-2 method.

The PSIP supports transmission of audio/video (A/V) data having MPEG-2 video and AC-3 audio formats and defines tables for transmission of information about channels of broadcasting stations and programs of the channels. Further, the PSIP supports selection of a desired channel for receiving a desired broadcasting A/V data (a main function) and an EPG service (a subsidiary function).

Here, information, such as channel information for selecting channels and packet identifier (PID) numbers for receiving A/V data, are transmitted using a virtual channel table, and EPG information for broadcast programs of channels is transmitted using an event information table (EIT).

The EIT contains information about virtual channel events such as title information and start time information. In the EIT, generally, one event corresponds to one broadcast program.

In the related art, title search can be performed using an EPG as follows. Referring to

FIG. 1, when a user inputs characters 10 representing a desired title, program titles including the characters 10 are displayed.

Next, the user can select one of the displayed program titles. Then, information about the selected program is displayed.

A method of searching an EPG will now be described in more detail according to the related art with reference to FIG. 2. In operations S11 to S12, a power-on command is input by a user, and an image received through an antenna is displayed.

In operation S13, it is determined whether an EPG title search command is input.

If so, a window is displayed for receiving characters from a user in operation S14.

In operation S15, program titles including the input characters are displayed.

In operation S16, it is determined whether a user inputs additional characters.

If so, the procedure returns to operation S14. If not, the procedure goes to operation

S17 where it is determined whether the EPG title search command is cancelled.

If the EPG title search command is cancelled, it is determined whether a power-off command is input in operation S18. If so, the procedure ends.

In the above-described EPG searching method of the related art, for example, a user may input three alphabet letters (A-Z) from the first blank of a character input screen.

After the user moves to the third blank using an arrow and fills the third blank, the user can press an OK button to display program titles including the three letters.

However, the related-art method is inconvenient for a user since the user should input a plurality of characters for searching for a desired program.

Furthermore, in the related-art method, it takes much time for searching an EPG for a desired program.

### DISCLOSURE OF INVENTION

### Technical Problem

Embodiments provide a method and apparatus for easily searching an electronic program guide (EPG) for a desired program.

Embodiments also provide a method and apparatus for rapidly searching an EPG for a desired program.

Embodiments also provide a method and apparatus for exactly searching an EPG for a desired program.

### Technical Solution

In an embodiment, there is provided an apparatus for searching an electronic program guide (EPG), the apparatus including: a key input unit receiving an external command; an EPG analyzer extracting EPG information from a received broadcast signal and analyzing the extracted EPG information; a memory storing information that is included in the EPG information analyzed by the EPG analyzer and corresponds to a command previously received from a user; and a controller allowing program representative title information to be displayed and searched when a program search command is received through the key input unit, the program representative title information being displayed in a predetermined sorting order determined by a language corresponding to the program search command.

In another embodiment, there is provided a method of searching an EPG, the method including: receiving a program title search command requesting a search of the EPG; searching for program representative title information corresponding to the program title search command; and displaying the program representative title information in a sequential order based on a user command.

In a further environment, there is provided a method of searching an EPG in a display device, the method including: receiving a program title search command requesting a search of the EPG; displaying program representative titles in a predetermined sorting order; when one of the program representative titles is selected, displaying program titles including the first character of the selected program representative title; and scheduling watching/recording of a program in response to a user request.

### ADVANTAGEOUS EFFECTS

The present disclosure provides a method and apparatus having the following advantages.

First, even when only a program search command is input, program representative titles detected from an EPG are display in a predetermined sorting order based on a selected language so that a program search screen can be more easily recognized.

Secondly, when program representative titles are displayed in a predetermined sorting order, a user can select one of the displayed program representative titles to display program titles having the same first character as the selected program representative title. Therefore, users can easily select a desired program.

Thirdly, a desired program can be searched for by selecting one of listed titles so that users can rapidly and exactly find a desired program. Thus, users can be satisfied.

### BRIEF DESCRIPTION OF THE DRAWINGS

FIG. 1 is a screen for explaining a method of searching an electronic program guide (EPG) according to the related art.

FIG. 2 is a flowchart for explaining a method of searching an EPG according to the related art.

FIG. 3 is a block diagram illustrating an apparatus for searing an EPG according to an embodiment.

FIG. 4 is a flowchart for explaining a method of searching an EPG according to an embodiment.

FIG. 5 is a screen for explaining a method of searching an EPG according to an embodiment.

FIG. 6 is a flowchart for explaining a method of searching an EPG according to another embodiment.

FIG. 7 is an exemplary screen for explaining the EPG searching method of FIG. 6.

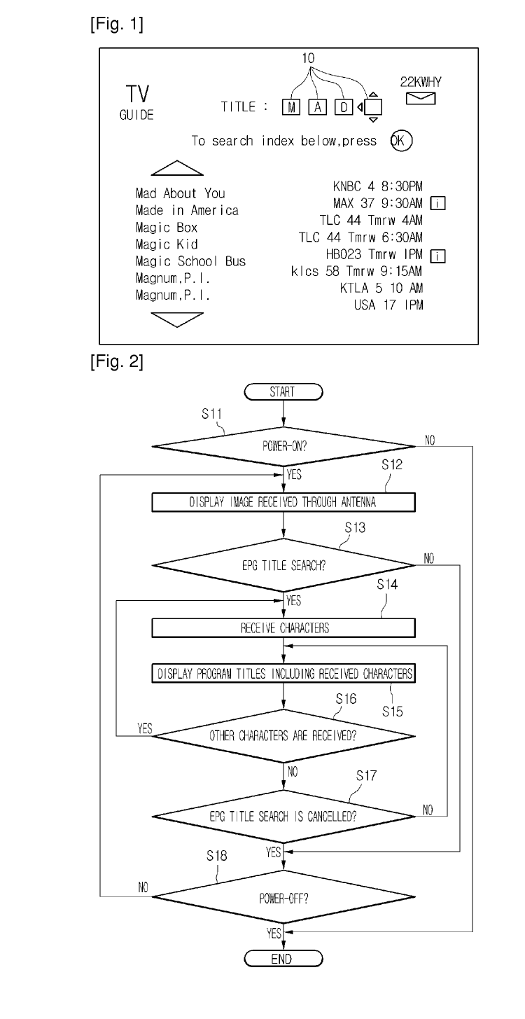

### BEST MODE FOR CARRYING OUT THE INVENTION

An apparatus and method for searching an electronic program guide (EPG) will now be described in detail with reference to the accompanying drawings, in which embodiments of the present disclosure are shown.

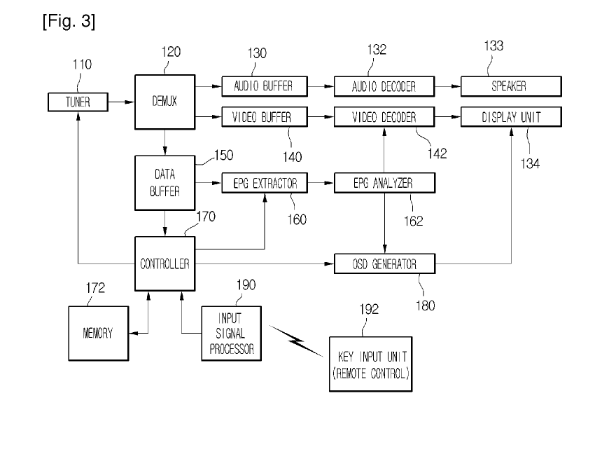

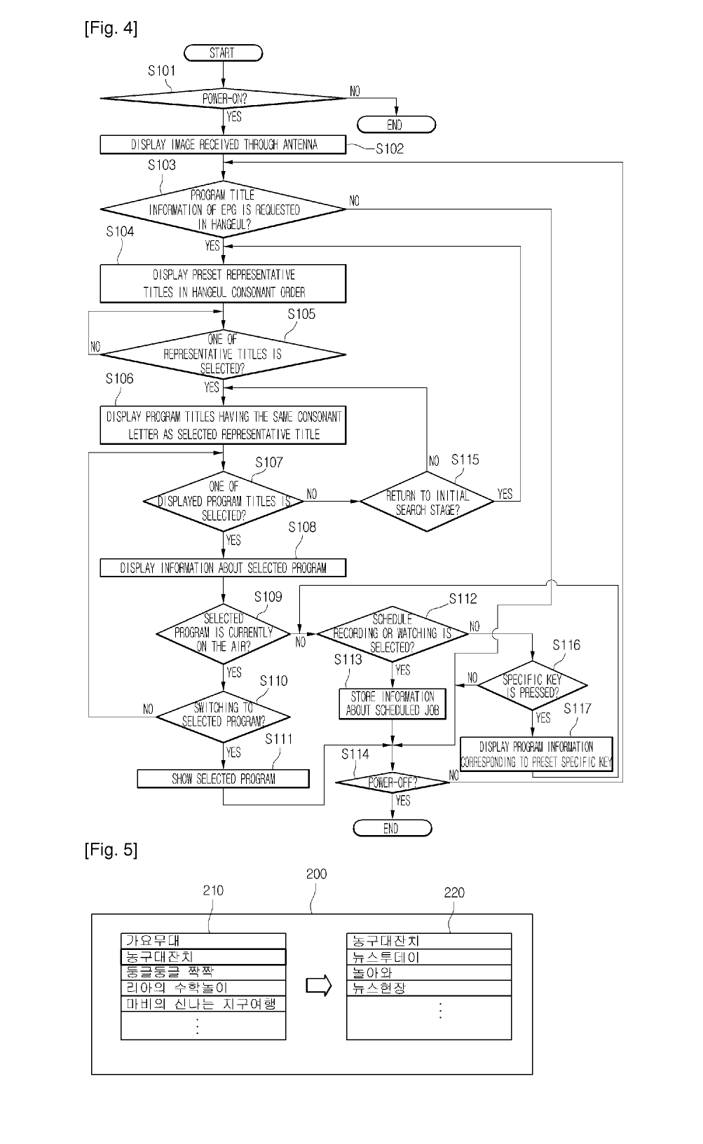

FIG. 3 is a block diagram illustrating an apparatus for searing an EPG according to an embodiment, FIG. 4 is a flowchart for explaining a method of searching an EPG according to an embodiment, and FIG. 5 is a screen for explaining a method of searching an EPG according to an embodiment.

Referring to FIG. 3, the EPG search apparatus of the current embodiment includes a tuner 110, a denims 120, an audio buffer 130, an audio decoder 132, a speaker 133, a video buffer 140, a video decoder 142, a display unit 134, a data buffer 150, an EPG extractor 160, an EPG analyzer 162, a controller 170, a memory 172, an on-screen display (OSD) generator 180, an input signal processor 190, and a key input unit 192 such as a remote controller.

The tuner 110 selects a specific broadcast channel according to a channel selection command received from the controller 170 for receiving a digital broadcast signal. The demix 120 parses a moving picture experts group (MPEG) transport stream of the digital broadcast signal into video, audio, and data signals.

The audio buffer 130 is a buffer for temporarily storing the audio signal separated by the denim 120. The audio decoder 132 receives the audio signal from the audio buffer 130 and decodes the audio signal for restoring the original audio signal that can be reproduced.

The video buffer 140 is a buffer for temporarily storing the video signal separated by the demur 120. The video decoder 142 receives the video signal from the video buffer 140 and decodes the video signal for restoring the original video signal that can be reproduced. The data buffer 150 is a buffer for temporarily storing the data signal separated by the denim 120.

The EPG extractor 160 extracts data related to an EPG (hereinafter, referred to as EPG data) from the data signal separated from the MPEG transport stream. The term “MPEG transport stream” or “transport stream” is used to refer to a stream of 184-byte packets and 4-byte headers added to the 184-packets, in which a plurality of video and audio packetized elementary streams (PESs) are combined. That is, the MPEG transport stream is a stream for transporting a plurality of video and audio data in the form of a single stream. The MPEG transport stream is also called “MPEP data”

The EPG data extracted by the EPG extractor 160 is input to the EPG analyzer 162 where the EPG data are analyzed and interpreted to provide EPG information. In response to a request of a user, the controller 170 extracts program information from the EPG information and controls the OSD generator 180 to display the extracted program information on a popup window of the display unit 134.

The memory 172 stores the EPG information and commands input by a user. When a user inputs an EPG search command using the key input unit 192 such as a remote controller, the OSD generator 180 allows program representative title information to be displayed on a popup window of the display unit 134.

In other words, when a user inputs an EPG search command using the key input unit 192, the controller 170 extracts title information from EPG information provided by the EPG analyzer 162. Then, program representative titles included in the title information may be displayed in a predetermined sorting order under the control of the controller 170.

The predetermined sorting order varies according to a language selected by a user. For example, when a Korean-alphabet (hangeul) command is input, program representative titles may be displayed in the order of hangeul consonant [symbol] When an English-alphabet command is input, program representative titles may be displayed in alphabetical order (A-Z).

Thereafter, when one of the program representative titles is selected, program titles having the same first character as the selected program representative title are searched for, and then the searched program titles are displayed.

For example, referring to FIG. 5, when a user inputs an EPG search command using the key input unit 192, the controller 170 extracts title information from EPG information provided by the EPG analyzer 162 so as to display program representative titles included in the title information in hangeul consonant order [symbol] [symbol] [symbol] [symbol] [symbol] [symbol] [symbol] [symbol] [symbol] and so on. Then, if a user selects [symbol] from the displayed program representative titles, program titles starting with [symbol] are displayed using a popup window.

According to an embodiment, a method of searching an EPG will now be described with reference to FIG. 4. In operations S101 to S102, a power-on command is input by a user, and an image received through an antenna is displayed.

In operation S103, it is determined whether program title information of an EPG is requested.

If so, preset representative titles of program titles are displayed in hangeul consonant order in operation S104.

In operation S105, it is determined whether one of the representative titles is selected.

If one of the representative titles is selected, program titles having the same consonant letter as the selected representative title are displayed in operation S106.

In operation S107, it is determined whether one of the displayed program titles is selected.

If one of the displayed program titles is selected, information about the selected program is displayed in operation S108.

In operation S109, it is determined whether the selected program is currently on the air.

If the selected program is currently on the air, the procedure goes to operation S110 where it is determined whether switching to the selected program is selected or not.

If switching to the selected program is selected, the selected program is showed in operation S111.

If the selected program is not currently on the air, the procedure goes to operation 112 where it is determined whether schedule recording or watching is selected.

If one of schedule recording and watching is selected, information about the scheduled job is stored in operation S113.

If a power-off commanded is input in operation S114, the procedure ends.

Meanwhile, in operation 5107, if one of the displayed program titles is not selected, the procedure goes to operation S115. In operation S115, it is determined whether the procedure returns to operation 5104 (an initial search stage).

For example, when it is determined in operation S115 that a user inputs an initial search command, the procedure returns to operation 5104 for new search.

Meanwhile, if schedule recording or watching is not selected in operation 5112, the procedure goes to operation S116 where it is determined whether a preset specific key is pressed.

If a preset specific key is pressed, program information corresponding to the preset specific key is displayed in operation S117.

As explained above, according to the EPG searching method and apparatus of the embodiments, when a program title search command is input in Korean language option, program representative titles including Korean characters are displayed in Korean alphabetical order [symbol] .

Thereafter, when one of the displayed program representative titles is selected, program titles starting with the same first Korean character as the selected program representative title are displayed.

Here, the displayed program representative titles can be changed according to, for example, user's fondness or genres.

Then, a user can select a desired program from the displayed program titles. In addition, information about the selected program and scheduled recording/watching of the selected program are available.

### MODE FOR THE INVENTION

Another embodiment provides a method of searching an EPG in non-Korean language environments such as English. The EPG searching method of the current embodiment may be applied to an EPG searching apparatus operating based on English.

The EPG searching method will now be described with reference to the accompanying drawings.

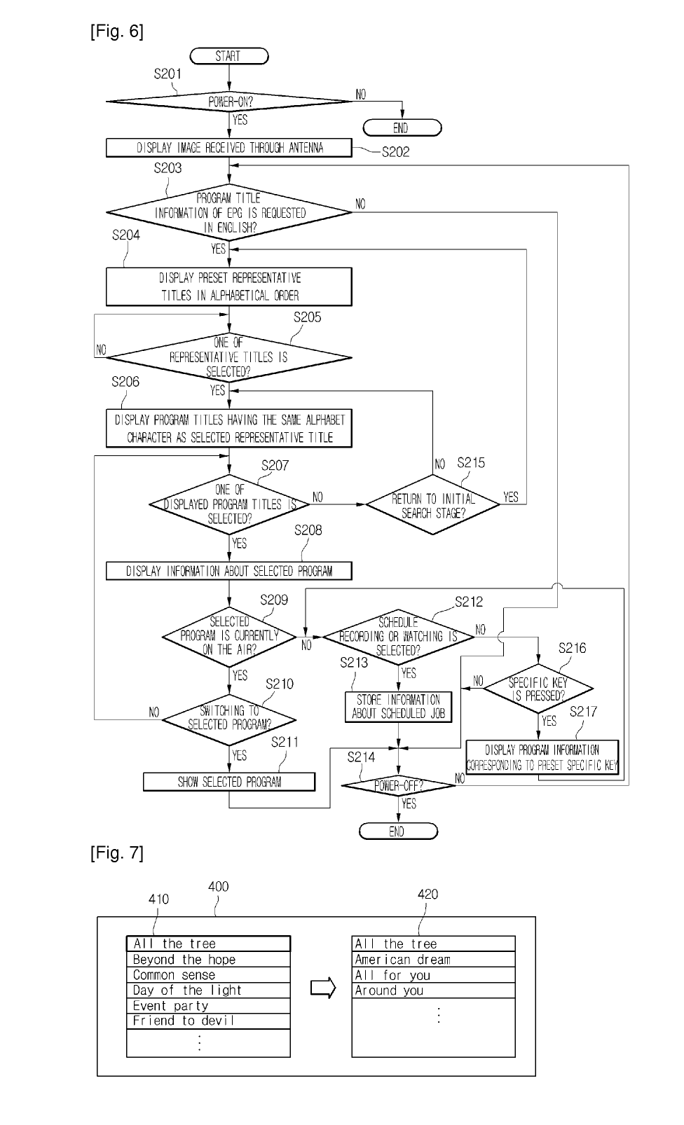

FIG. 6 is a flowchart for explaining a method of searching an EPG according to another embodiment, and FIG. 7 is an exemplary screen for explaining the EPG searching method of FIG. 6.

Referring to FIG. 6, in operations 5201 to 5202, a power-on command is input by a user, and an image received through an antenna is displayed.

In operation 5203, it is determined whether program title information of an EPG is requested.

If so, preset representative titles of program titles are displayed in alphabetical order in operation 5204.

In operation 5205, it is determined whether one of the representative titles is selected.

If one of the representative titles is selected, program titles including the first alphabet character of the selected representative title are displayed in operation 5206.

In operation 5207, it is determined whether one of the displayed program titles is selected.

If one of the displayed program titles is selected, information about the selected program is displayed in operation 5208.

In operation 5209, it is determined whether the selected program is currently on the air.

If the selected program is currently on the air, the procedure goes to operation 5210 where it is determined whether switching to the selected program is performed or not.

If switching to the selected program is selected, the selected program is showed in operation 5211.

If the selected program is not currently on the air, the procedure goes to operation 212 where it is determined whether schedule recording or watching is selected.

If one of schedule recording and watching is selected, information about the scheduled job is stored in operation 5213.

If a power-off commanded is input in operation 5214, the procedure ends.

Meanwhile, in operation 5207, if one of the displayed program titles is not selected, the procedure goes to operation 5215. In operation 5215, it is determined whether the procedure returns to operation 5204 (an initial search stage).

For example, when it is determined in operation 5215 that a user inputs an initial search command, the procedure returns to operation 5204 for new search.

Meanwhile, if schedule recording or watching is not selected in operation 5212, the procedure goes to operation 5216 where it is determined whether a preset specific key is pressed.

If a preset specific key is pressed, program information corresponding to the preset specific key is displayed in operation 5217.

As explained above, according to the EPG searching method of the embodiment, when a program title search command is input, program representative titles including alphabet characters are displayed in alphabetical order (A-Z). Thereafter, when one of the displayed program representative titles is selected, program titles including the first alphabet character of the selected program representative title are displayed.

Here, the displayed program representative titles can be changed according to, for example, user's fondness or genres.

Then, a user can select a desired program using the displayed program titles. In addition, information about the selected program and scheduled recording/watching of the selected program are available.

As described above, the EPG searching method of the current embodiment provides an easy way of searing an EPG for desired programs. For example, referring to FIG. 7, when a user inputs a program search command, program representative titles 410 are displayed in alphabetic order: “All the tree”, “Beyond the hope”, “Common sense”, “Day of the light”, “Event party”, “Friend to devil”, and so on.

Then, if a user selects “All the tree” from the displayed program representative titles 410, program titles starting with “A” are displayed on an additional popup window 420.

Any reference in this specification to “one embodiment,” “an embodiment,” “exemplary embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An apparatus for searching an electronic program guide, the apparatus comprising:
a key input unit receiving an external command;
an electronic program guide analyzer extracting electronic program guide information from a received broadcast signal and analyzing the extracted electronic program guide information;
a memory storing information that is included in the electronic program guide information analyzed by the electronic program guide analyzer and corresponds to a command previously received from a user;
a controller allowing program representative title information to be displayed and searched when a program search command is received through the key input unit, the program representative title information being displayed in a predetermined sorting order determined by a language corresponding to the program search command; and
a display unit displaying the program representative title information according to a control signal received from the controller.

2. The apparatus according to claim 1, wherein the program representative title information comprises popular program titles, and the popular program titles are displayed in a predetermined sorting order based on the first characters of the popular program titles.

3. The apparatus according to claim 1, wherein the program representative title information comprises popular actor/actress names, and the popular actor/actress names are displayed in a predetermined sorting order based on the first characters of the popular actor/actress names.

4. The apparatus according to claim 1, wherein the program representative title information comprises program titles representing genres, and the program titles are displayed in a predetermined sorting order based on the first characters of the program titles.

5. The apparatus according to claim 1, wherein the program representative title information is displayed in a sequential order.

6. The apparatus according to claim 1, wherein when one of program representative titles displayed on the display unit is selected, the display unit displays program titles having the same first character as the selected program representative title in a sequential order.

7. A method of searching an electronic program guide, the method comprising:
receiving a program title search command requesting a search of the electronic program guide;
searching for program representative title information corresponding to the program title search command; and
displaying the program representative title information in a predetermined sorting order based on a user command.

8. The method according to claim 7, wherein the displaying of the program representative title information comprises displaying popular program titles in a predetermined sorting order based on a user command.

9. The method according to claim 7, wherein the displaying of the program representative title information comprises displaying popular actor/actress names in a predetermined sorting order based on a user command.

10. The method according to claim 7, further comprising displaying program titles having the same first character as the selected program representative title when one of displayed program representative titles is selected.

11. The method according to claim 10, wherein the displaying of the program titles is performed by displaying only the program titles on a popup window.

12. The method according to claim 7, wherein the program representative title information is displayed in a sequential order.

13. A method of searching an electronic program guide in a display device, the method comprising:
receiving a program title search command requesting a search of the electronic program guide;
displaying program representative titles in a predetermined sorting order;
when one of the program representative titles is selected, displaying program titles including the first character of the selected program representative title; and
scheduling watching/recording of a program in response to a user request.

14. The method according to claim 13, wherein the displaying of the program titles comprises displaying a program plot or detailed actor/actress information using a popup window when a predetermined specific key is pressed.
